(19) United States
(12) Patent Application Publication
(10) Pub. No.: US 2015/0082238 A1
(43) Pub. Date: Mar. 19, 2015

(54) SYSTEM AND METHOD TO DISPLAY AND INTERACT WITH A CURVE ITEMS LIST

(71) Applicant: Jianzhong Meng, Calgary (CA)

(72) Inventor: Jianzhong Meng, Calgary (CA)

(21) Appl. No.: 14/029,988

(22) Filed: Sep. 18, 2013

(51) Int. Cl. G06F 3/0482; G06F 3/0485

(52) U.S. Cl. CPC G06F 3/0482; G06F 3/04855
USPC 715/786; 715/840

(57) ABSTRACT

A system and method is provided to display and interact with a plurality of items with text(s) and/or image(s) in a curve shaped area on a touch screen of an electronic device. In this invention, “finger” refers to either a human being finger or a stylus pen. Users may use a finger to vertically scroll through a curve items list to see all items that may not be once displayed on the touch screen with a limited size. Also, users may use a finger to tap a specific item to highlight and select it. Additionally, users may use a finger to swipe leftward or rightward a particular item. Furthermore, users may use 2 fingers to squeeze 2 different items, and all other items sandwiched by these 2 items if applicable, towards each other. Finally, the described technique can be used in an electronic device with keyboard and/or mouse, and users may use keyboard and/or mouse instead of finger to vertically scroll through a curve items list and select a specific item.

### BACKGROUND

For an electronic device with a touch screen, users are often prompted a plurality of items with text(s) and/or image(s), such as, but not limited to, email messages list, contacts list, files list, music list, and friends, followers and following lists of social networking sites. Additionally, users may interact with the items list to perform associated functions. Furthermore, an electronic device with a touch screen may be a wireless phone, a tablet, a laptop or desktop computer, a personal digital assistant, a game console, a vehicle digital dashboard, a copy/printer/scanner digital control panel, an appliance digital control panel, or any combination thereof.

Often, a rectangle shaped display area is used to populate a plurality of items, and each item occupies a small rectangle area to render contained text(s) and/or image(s). Additionally, scrollbars can be used to indicate which part of the items list is visible if the display area cannot accommodate all items.

### SUMMARY

We propose a system and method to populate a plurality of items in a curve shaped area, and the items are displayed vertically inside a curve shaped area. Furthermore, each item contains text(s) and/or image(s) that are rendered along a curve path. More specifically, different items occupy different amount of display space. Additionally, users may user a finger to vertically scroll through a curve items list to see all items that cannot be once displayed on a touch screen with a limited size, and thus two scrollbars can be used to indicate the motion direction and which part of the items list is visible.

Alternatively, users may user a finger to swipe leftward or rightward one particular item. Also, users may use two fingers to squeeze two different items towards each other, and users may simply tap one particular item to highlight and select it.

Finally, A few images buttons are displayed in the empty area that is beyond the curve shaped area. Therefore, these image buttons can allow users to interact with the curve items list itself, software, firmware, or combinations thereof.

### BRIEF DESCRIPTIONS OF THE DRAWINGS

FIG. 1 is an illustration of an exemplary implementation showing a curve items list.

FIG. 2 is a system architecture layout for an electronic device with a touch screen, a curve items list controller, and other critical modules.

FIG. 3 is an illustration of an exemplary implementation in which email messages are populated in a curve shaped area.

FIG. 4A-B are two illustrations of an exemplary implementation in which a vertical scrolling is shown.

FIG. 5A-D are four illustrations of an exemplary implementation in which a leftward swipe and a rightward swipe are shown.

FIG. 6A-B are two illustrations of an exemplary implementation in which two different items squeezed towards each other are shown.

FIG. 7A-B are 2 illustrations of an exemplary implementation in which a tapping action is shown.

FIG. 8 is a flow chart depicting a procedure in an exemplary implementation to handle scrolling, leftward or right swiping, squeezing, and tapping actions that may occur in a curve items list.

### THE DETAILED DESCRIPTION OF THE INVENTION

In the following description, many details are set forth for the purpose of explanation rather than limitation. However, it is well understood by one skilled in art that the invention may be practiced without the use of these specific details. Furthermore, the invention can be used in an electronic device with keyboard and/or mouse, and users may use keyboard and/or mouse instead of finger to vertically scroll through a curve items list and select a specific item.

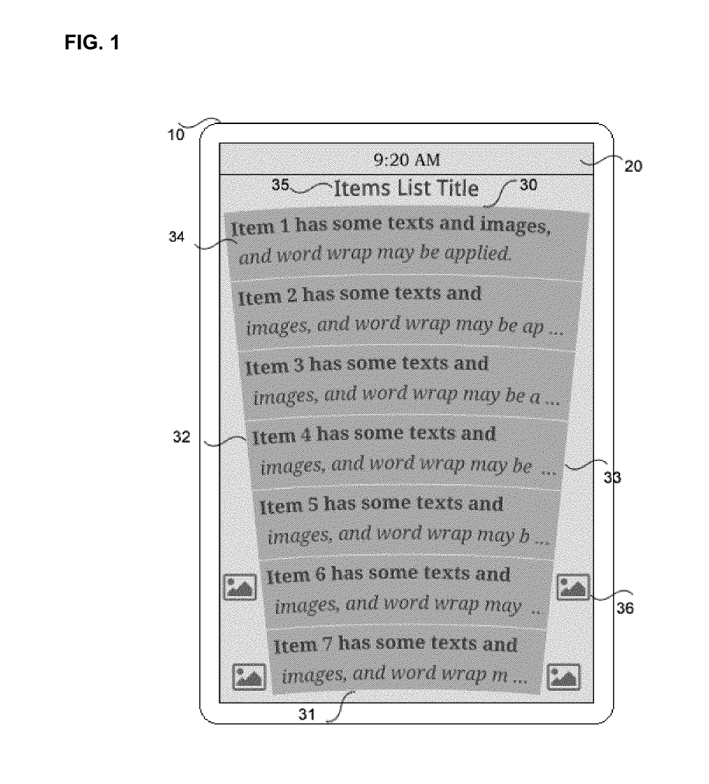

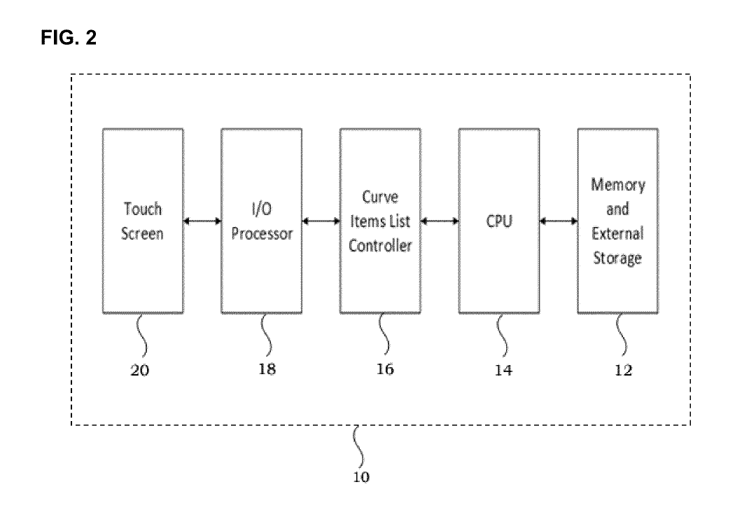

For FIG. 1, a curve list with a plurality of items is displayed on an electronic device 10 with a touch screen 20. Furthermore, the curve zone consists of 4 sections: the top curve section 30, the bottom curve section 31, the left tilted line 32, and the right titled line 33. Also, The left tilted line 32 and the right tilted line 33 are symmetrical along the vertical central line of the touch screen 20. Also, the size of the top curve 30 is greater than the size of the bottom curve 31, and they share same curvature; in other words, they are parallel. Additionally, the geometric aspects of 4 sections can be configured in a variety of ways to meet the requirements of different applications. For example, the size of the top curve 30 may be less than the size of the bottom curve 31; the top and bottom curves can be concave instead of convex. Furthermore, the title 35 of the curve items list is displayed in a curve fashion on the top of the curve zone. The touch screen 20 is operated in the portrait mode, and it is well understood that the touch screen 20 can be operated in the landscape mode.

More specifically, each item 34 of the curve list can be configured to include text(s) and/or image(s) that may be grouped into a few curve lines, each text or image therein can be rendered differently and independently (e.g., text color and alignment, font characteristics, background color, image drawing effect, etc.) along an invisible curve path. Finally, there are 4 images buttons 36 located in the empty area beyond the curve items list, and thus users may click these buttons 36 to interact with the curve items list, software, firmware, or combinations thereof. Alternatively, if the size of top curve 30 is less than the size of bottom curve 31, these image buttons 36 can be populated in the top left and top right corners of the touch screen 20 instead of the bottom left and bottom right corners of the touch screen 20.

For FIG. 2, an electronic device 10 with a touch screen 20 usually includes the I/O processor 18 that acts as a bridge between the touch screen 20 and the curve items list controller 16. In other words, the touch input data can be sent from the touch screen 20 to the curve items list controller 16; the text and/or image rendering data can be sent from the curve items list controller 16 to the touch screen 20. Additionally, the curve items list controller 16 can be implemented using software, firmware, or a combination thereof. Furthermore, the curve items list controller 16 can accept data from a variety of data sources to generate the list. For example, the data source can be a physical file, a few database records, some application specific in-memory data, a contacts list in wireless phones, a few email messages, music collections in media players, a files list of a local or cloud storage, friends, followers, and following lists of social networking sites, and so on. Additionally, an electronic device 10 contains the central processing unit (CPU) 14 that is the command center to execute and coordinate major computing tasks; an electronic device 10 contains the memory and external storage 12 to store firmware, software applications, critical data, and temporary data generated by executed software applications and firmware. Finally, all modules 20, 18, 16, 14, 12 frequently communicate with each other to ensure the electronic device 10 runs as smoothly as expected, and an electronic device 10 may contain other modules such as keyboard, mouse, network adapter, Wi-Fi adapter, antenna, battery, USB adapter, and so on.

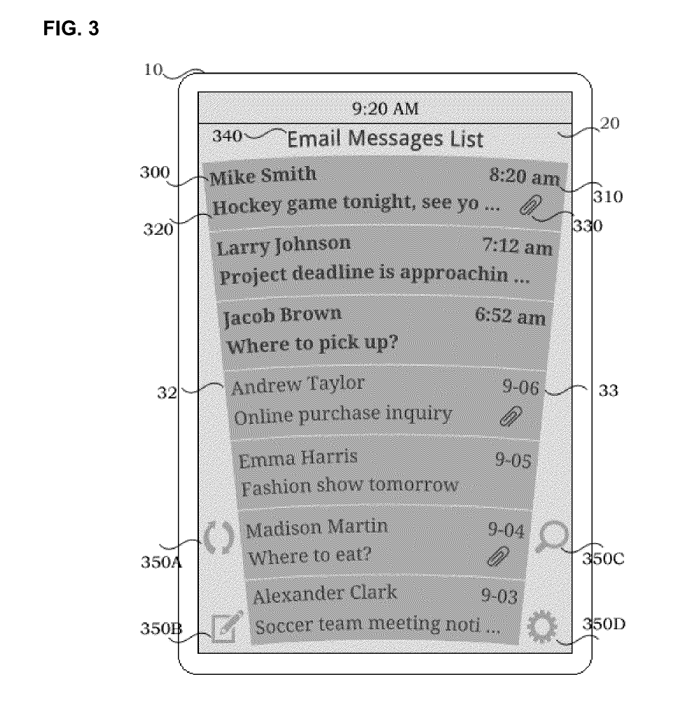

For FIG. 3, a few email messages are populated in a curve shaped area. Each email message has the sender name 300, the received date 310, the subject 320, and the possible attachment icon 330 indicating that the email message contains attachment(s). Additionally, the textual and graphical data thereof are grouped into 2 curve lines. Furthermore, the first curve line contains the sender name 300 and the received date 310; the second curve line contains the subject 320 and the attachment icon 330 if applicable. The texts are rendered in a bold mode for the emails that have not been read yet; otherwise the texts are rendered in a regular mode.

More specifically, the received date 310 of the first curve line is rendered in a curve fashion and there is a small margin between the right side of the received date 310 and the right tilted line 33. The remaining part is the sender name 300, thereby a mathematical computation is involved to determine whether or not the remaining curve space between the left tilted line 32 and the left side of the received date 310 is big enough to accommodate the sender name 300. Also, a small margin among the left tilted line 32, the sender name 300, and the received date 310 is contemplated when conducting the computation. If the remaining curve space is big enough, the entire sender name 300 is rendered therein; otherwise a truncation process is applied to the sender name 300 to obtain the partial string thereof which can fit the remaining curve space, and thus the obtained partial string is rendered in a curve fashion to occupy the remaining curve line space.

For the second curve line, if the attachment icon 330 is required to indicate the attachment existence of the email message, the attachment icon 330 close to the right tilted line 33 is rendered there. Finally, for the subject 320, a mathematical computation is involved to determine whether or not the curve space between the left tilted line 32 and the attachment icon if applicable or the right tilted line 33 is big enough to accommodate the subject 320, a small margin among the left tilted line 32, the subject 320, the attachment icon 330 if applicable, and the right tilted line 33 is contemplated when conducting the computation. If the curve space is big enough, the entire subject 320 is rendered in a curve fashion; otherwise, a truncation process is applied to the subject 320 to obtain the partial string that can fit the remaining curve space, and thus the obtained partial string is rendered there in a curve fashion.

Also, the presentation style (e.g., text color and alignment, font characteristics, background color, image drawing effect, etc.) of the sender name 300, the received date 310, and the subject 320, and the attachment icon 330 if applicable can be configured in a variety of ways.

Finally, the list title 340 is displayed on the top of the curve item list, and 4 image buttons 350A (Refresh), 350B (Compose), 350C (Search), and 350D (Settings) are displayed, so users can interact with the email application hosting a curve items list.

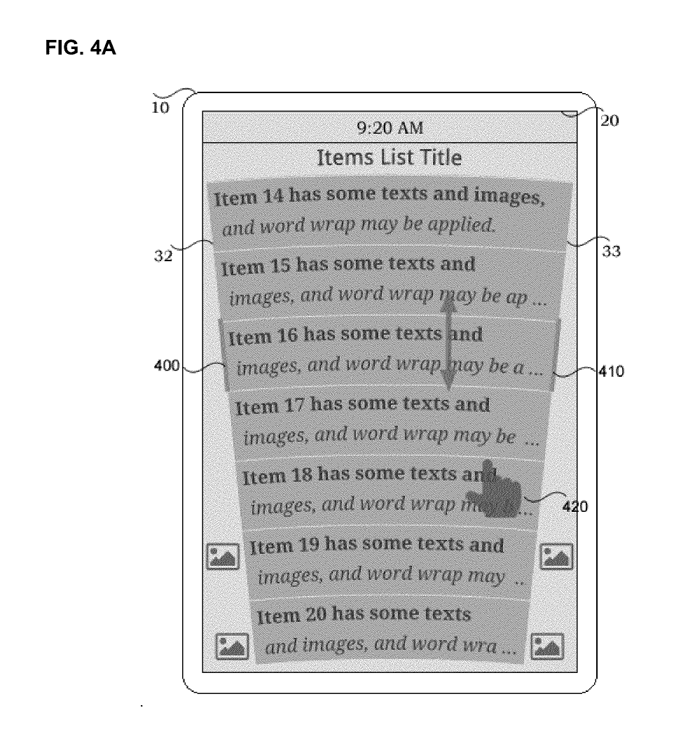

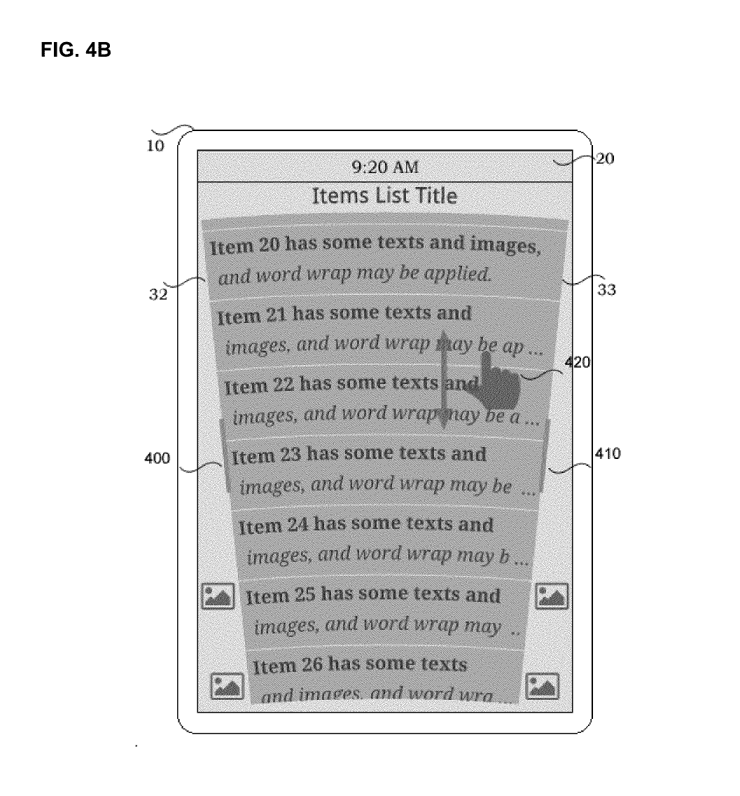

For FIG. 4A-B, a finger touches the screen 20 of an electronic device 10 and starts to vertically scroll through the curve list, therefore the curve list controller 16 detects whether or not it is a legitimate vertical motion; if so, some visible items are moved out the curve zone and some invisible items are moved into the curve zone, 2 scrollbars 400 and 410 are rendered along the left tilted lines 32 and the right tilted line 33 respectively. The scrollbars 400 and 410 are displayed to indicate the motion direction and which part of the items list is currently in the visible curve zone. Furthermore, the scrollbars 400 and 410 will fade out within a predetermine amount of time. The length of the scrollbars 400 and 410 depends on the ratio between the number of visible items and the number of all items; the bigger the ratio is, the longer the scrollbars are. Finally, the width and the color of the scrollbars 400 and 410 can be configured.

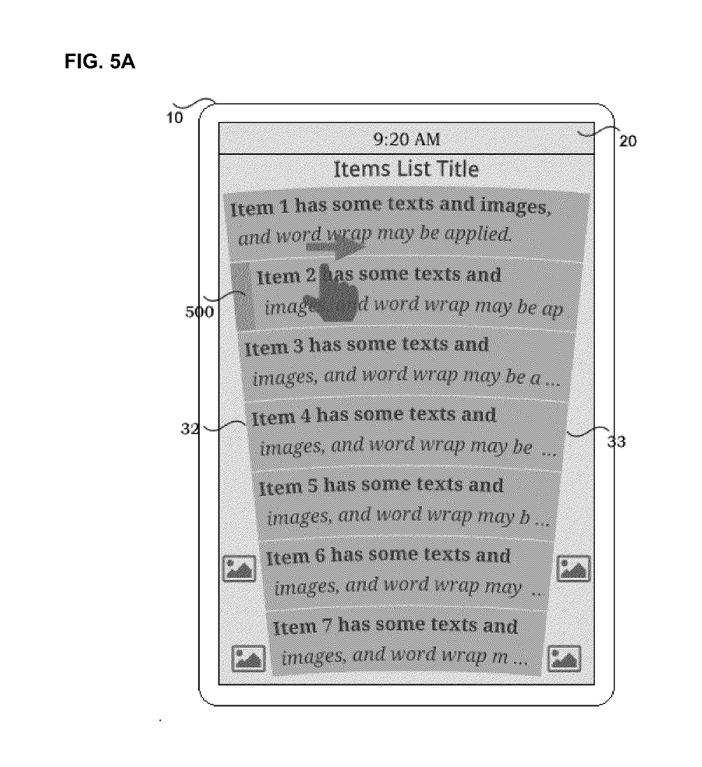

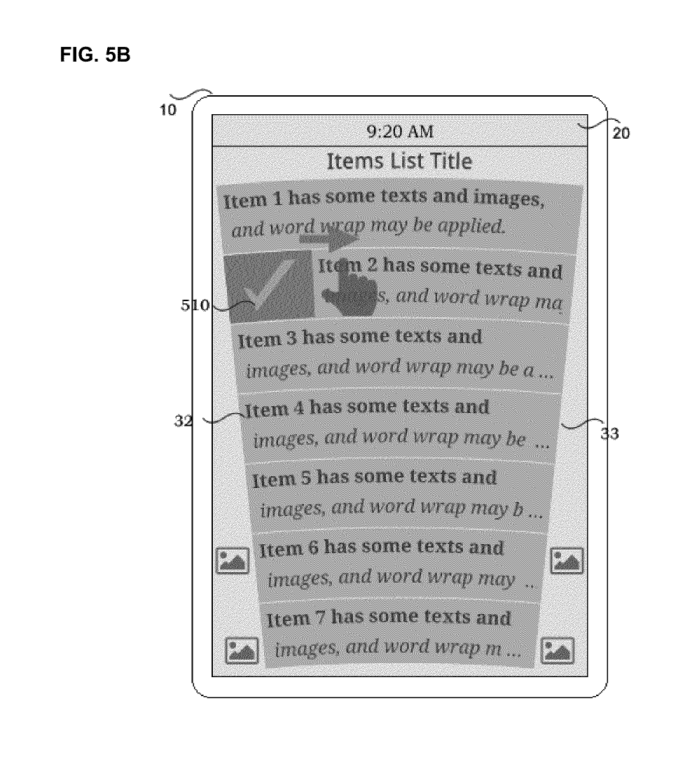

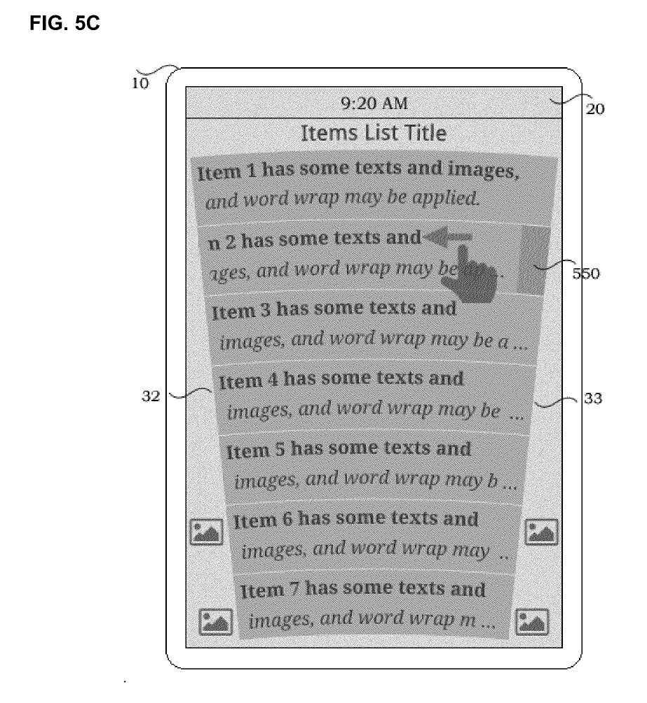

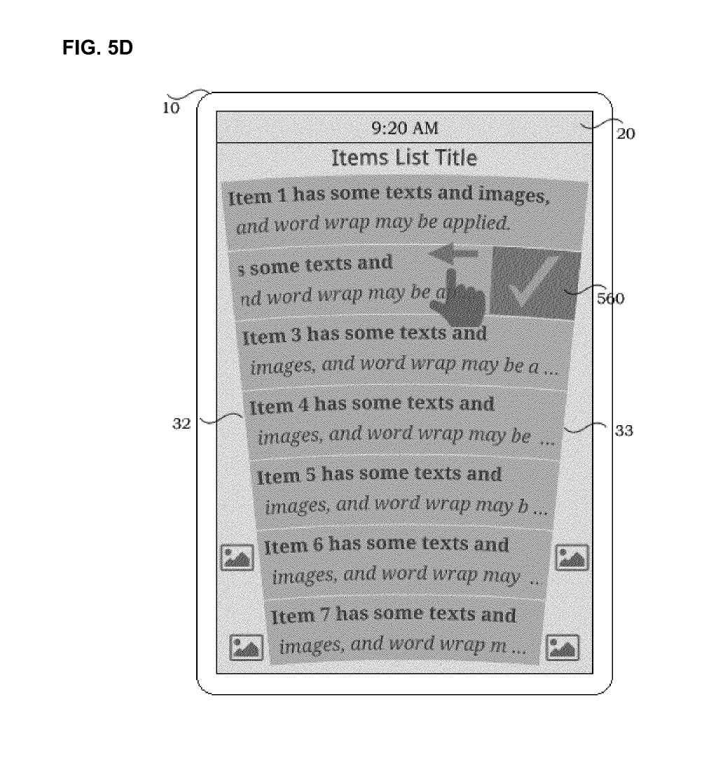

For FIG. 5A-B, the item 2 is utilized to illustrate a rightward swipe, it is well understood that a rightward swipe can be applied to any visible item. A finger touches the curve area of the touch screen 20 on an electronic device 10, the curve list controller 16 detects that the touchdown location is inside the item 2 area. Furthermore, the curve list controller 16 concludes that touchdown is not a tapping action; instead it is a rightward swipe. Therefore, a conversion process is applied to convert the rightward swipe to a corresponding clockwise rotation along the curve path of the item 2, and thus the item 2 is redrawn accordingly, the trailing empty area 500 of the item 2 is filled with a predetermined background color, and it is well understood that the trailing empty area 500 can be configured to display meaningful text(s) and/or image(s) with a variety of presentation styles (e.g., text color and alignment, font characteristics, background color, image drawing effect, etc.). If the rotation angle is equal to or greater than a predetermine value, the trailing empty area 500 is transformed to the trailing empty area 510 with different presentation styles. For example, a check mark can be displayed, and it is well understood that the trailing empty area 510 can be configured to display meaningful text(s) and/or image(s) with a variety of presentation styles (e.g., text color and alignment, font characteristics, background color, image drawing effect, etc.). Furthermore, an event is generated and sent to the curve list controller 16, and the curve list controller 16 can transfer the event to a software program, a firmware module, or a combination thereof that performs associated functions. For example, in the email messages list, if one email message item is swiped rightward to a certain point, an event is transferred via the curve list controller 16 to the email application hosting the email messages list, and the email application can delete that specific email message.

For FIG. 5C-D, the item 2 is utilized to illustrate a leftward swipe, it is well understood that a leftward swipe can be applied to any visible item. A finger touches the curve area of the touch screen 20 on an electronic device 10, the curve list controller 16 detects that the touchdown location is inside the item 2 area. Furthermore, the curve list controller 16 concludes that touchdown is not a tapping action; instead it is a leftward swipe. Therefore, a conversion process is applied to convert the leftward swipe to a corresponding anticlockwise rotation along the curve path of the item 2, and thus the item 2 is redrawn accordingly, the trailing empty area 550 of the item 2 is filled with a predetermined background color, and it is well understood that the trailing empty area 550 can be configured to display meaningful text(s) and/or image(s) with a variety of presentation styles (e.g., text color and alignment, font characteristics, background color, image drawing effect, etc.). If the rotation angle is equal to or greater than a predetermine value, the trailing empty area 550 is transformed to the trailing empty area 560 with different presentation styles. For example, a check mark can be displayed, and it is well understood that the trailing empty area 560 can be configured to display meaningful text(s) and/or image(s) with a variety of presentation styles (e.g., text color and alignment, font characteristics, background color, image drawing effect, etc.). Furthermore, an event is generated and sent to the curve list controller 16, and the curve list controller 16 can transfer the event to a software program, a firmware module, or a combination thereof that performs associated functions. For example, in the email messages list, if one email message item is swiped leftward to a certain point, an event is transferred via the curve list controller 16 to the email application hosting the email messages list, and the email application can allow the user to reply to that specific email message.

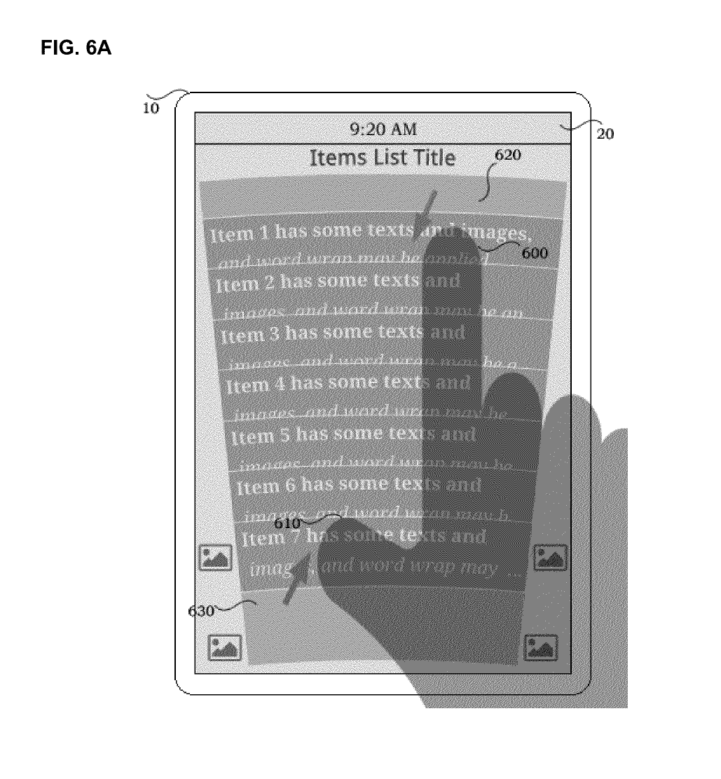

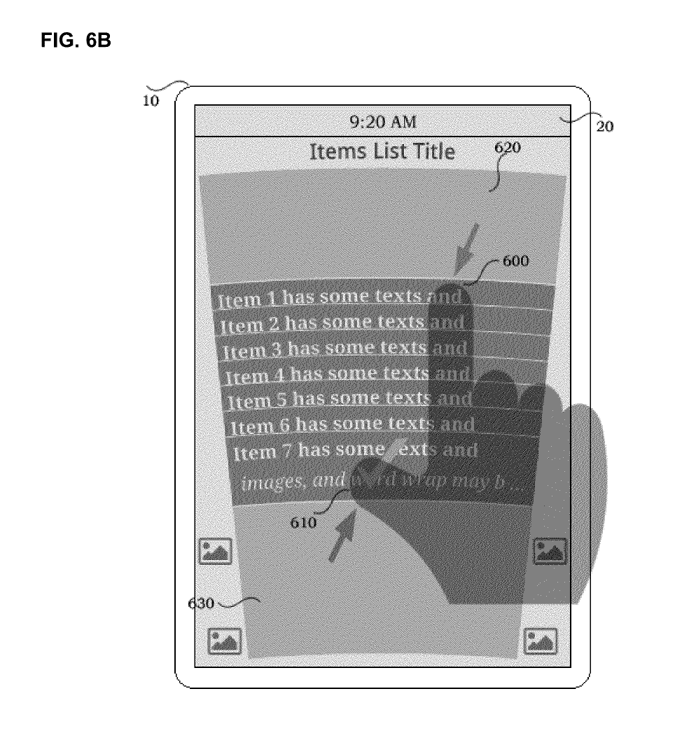

For FIG. 6A-B, two fingers 600 and 610 touch two different items of a curve items list on the touch screen 20 of an electronic device 10, and thus the locations of two touchdowns are captured. Particularly, in this example, the item 1 and the item 7 are touched, and it is well understood that any 2 different items can be touched. Furthermore, the curve list controller 16 detects two fingers squeezing towards each other, so the vertical displacements of two fingers are computed, and thus the item 1 and the item 7 are re-populated accordingly. Therefore, the items 2-6 are pushed towards each other to evenly overlap each other; the background color and text color of all affected items are changed to the predetermined colors. Additionally, the empty areas 620 and 630 are filled with a predetermine background color, and it is well understood that the empty areas 620 and 630 can be configured to display meaningful text(s) and/or image(s) with a variety of presentation styles (e.g., text color and alignment, font characteristics, background color, image drawing effect, etc.). If the vertical distance between two fingers 600 and 610 is equal to or less than a predetermined value, the background color and text color of all affected items (Items 1 to 7) can be changed to the predetermined colors. Additionally, an event is generated and sent to the curve list controller 16, and the curve list controller 16 can transfer the event to a software program, a firmware module, or a combination thereof that performs associated functions. For example, in the email messages list, if two email messages are squeezed towards each other by two fingers to a certain point, an event is transferred via the curve list controller 16 to the email application hosting the email messages list, and the email application can delete these 2 touched email messages and all sandwiched email messages.

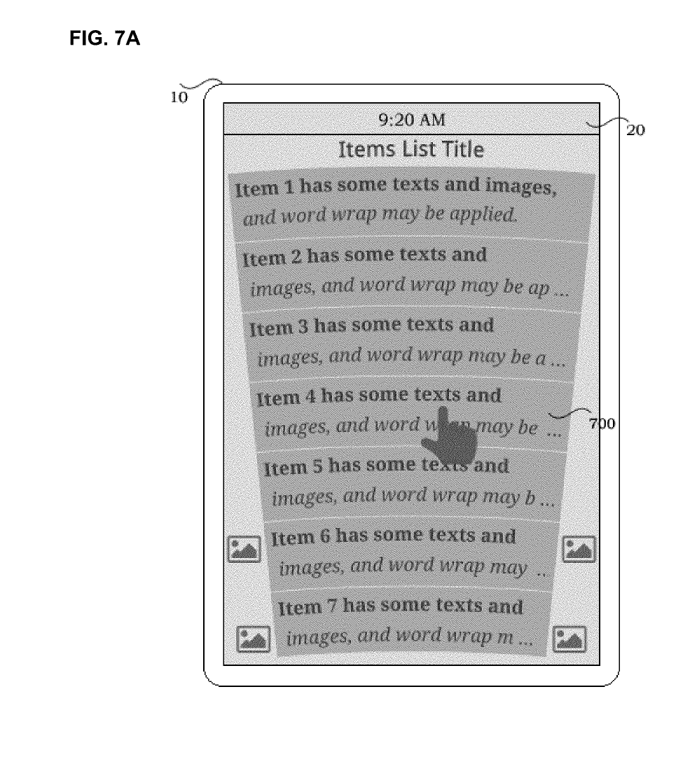

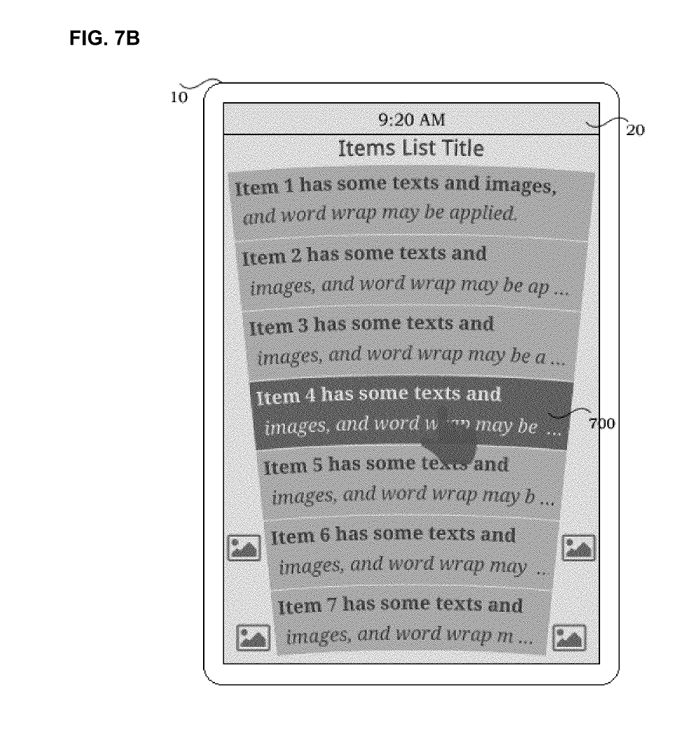

For FIG. 7A-B, the item 4 is utilized to illustrate a tapping action, and it is well understood that a tapping action can be applied to any visible item. The curve list controller 16 detects that a finger touches the small curve area 700 of the item 4 and the touchdown elapse time is equal to or greater than a predetermine amount of time, and thus the background color and text color of the item 4 are changed to the predetermined colors. Therefore, an event is generated and sent to the curve list controller 16, and the curve list controller 16 may transfer the event to a software program, a firmware module, or a combination thereof that performs associated functions. For example, in the email messages list, if one specific email messages is tapped by a finger, an event is transferred via the curve list controller 16 to the email application hosting the email messages list, the email application can open up another window to view the detailed information of that specific email message.

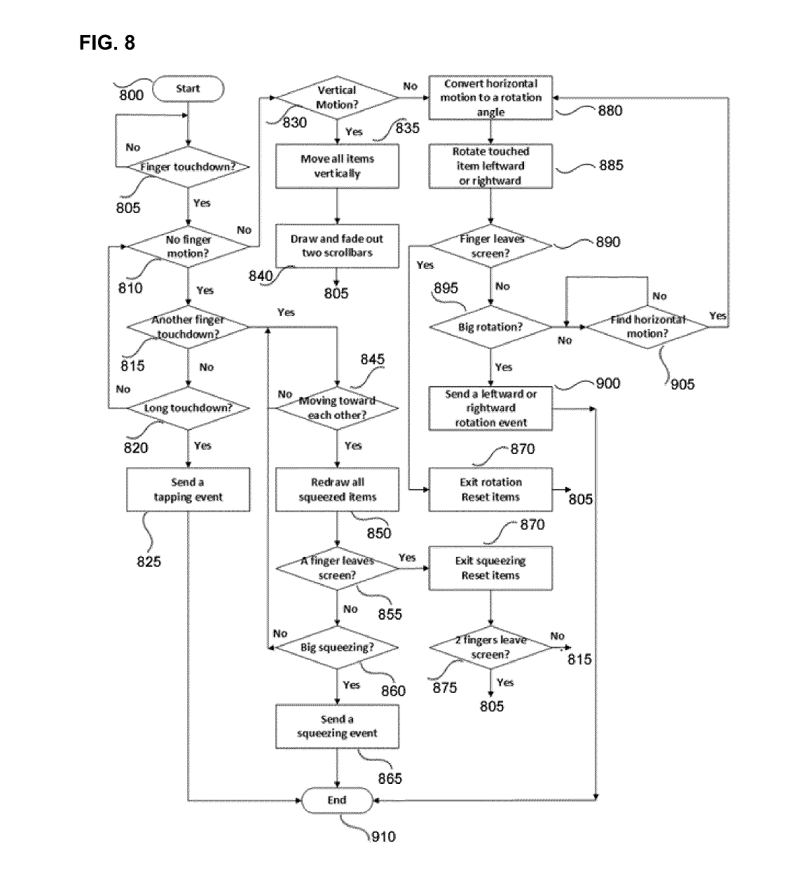

For FIG. 8, in block 805, a finger touchdown event that occurs inside the curve list area is received and the location of touchdown and time are captured. In block 810, it is determined whether or not a finger movement is detected. If not, in block 815, it is determined whether or not a second finder touchdown is detected. If not, in block 820, the touchdown elapse time is computed to see whether or not it is equal to or greater than a predetermined amount of time (e.g., 0.2 second). If so, in block 825, the tapped item index is computed and a tapping event is generated and sent to a software program, a firmware module, or a combination thereof that performs associated functions. For example, in the email application hosting a curve items list containing email messages, if one specific email item is tapped, another window will be opened up to view the detailed information of that specific email message. In block 820, if the touchdown elapse time is less than a predefined threshold (e.g., 0.2 second), the procedure moves back to block 810.

In block 810, if single finger motion is detected, the procedure moves to block 830, wherein it is determined whether or not the motion is vertical, the technique on how to identify a motion as a vertical or horizontal one is to compare the ratio between the vertical speed and the horizontal speed, if the ratio exceeds a predetermine value (e.g., 1), the motion is interpreted as a vertical one; otherwise the motion is interpreted as a horizontal one. In block 835, the vertical motion is detected and all items are moved vertically; in other words, some visible items are moved out of the curve area, therefore some invisible items are moved into the curve area. In block 840, 2 scrollbars are displayed and faded out to indicate the motion direction and which part of the items list is visible in the curve area. Finally, the procedure moves back to the block 805.

In block 830, if the horizontal motion is detected, the procedure moves to block 880, wherein the horizontal motion is converted to a rotation angle. Furthermore, in block 885, the targeted item is rotated leftward or rightward accordingly. In block 890, it is determined whether or not the finger leaves the targeted item curve area or the touch screen 20. If so, the rotation is finished, thus in block 870, the targeted item is reset to the original status and redrawn accordingly, and the procedure moves back to block 805. If the finger still touches the targeted item curve area, in block 895, it is determined whether or not the rotation angle is equal to or greater than a predetermined value. If so, in block 900, a leftward or rightward rotation event is generated and sent to a software program, a firmware module, or a combination thereof that performs functions associated with this event. For example, in the email application hosting a curve items list containing email messages, if one specific email item is rotated leftward to a certain point, a deleting event can be generated and sent to the email application. Likewise, if one specific email item is rotated rightward to a certain point, a replying event can be generated and sent to the email application. In block 895, if the rotation angle is less than a predetermined value, the procedure moves to block 905, wherein a loop process occurs until a new horizontal motion is detected.

In block 815, if a second finger touchdown is detected, the procedure moves to block 845, wherein it is determined whether or not 2 fingers move towards each other. If not, a loop process occurs in block 815 until 2 fingers move towards each other. If 2 fingers indeed move towards each other, in block 850, 2 items touched by 2 fingers and all items sandwiched by these 2 items are redrawn to evenly overlap each other. Furthermore, in block 855, it is determined whether or not at least one finger leaves the touch screen 20. If not, in block 860, it is determined whether or not the squeezing size is equal to or greater than a predetermined value. If so, in block 865, a squeezing event is generated and sent to a software program, a firmware module, or a combination thereof that performs functions associated with this event. For example, in the email application hosting a curve items list containing email messages, if 2 email messages are squeezed to a certain point, these 2 email messages and all email messages sandwiched by these 2 email messages are deleted by the email application.

In block 855, if at least one finger leaves the touch screen 20, the squeezing process is finished. Therefore, in block 870, all items affected by the squeezing process are reset and redrawn accordingly. Furthermore, in block 875, it is determined whether or not 2 fingers leave the touch screen 20. If so, the procedure moves back to block 805; otherwise, the procedure moves back to block 815.

What is claimed is:

1. A method comprising:
receiving a plurality of items with text(s) and/or image(s) from difference data sources;
populating a plurality of items in a curve shaped area;
populating a plurality of image buttons beyond the curved shaped area; and
receiving and responding to 4 different touch inputs—scrolling, leftward or rightward swiping, squeezing, and tapping.

2. The method of claim 1, wherein said data source includes, but not limited to, physical file, database records, application specific in-memory data, contacts list in wireless phones, email messages, music collections in media players, files list of a local or cloud storage, friends, followers, and following list of social networking sites, and so on.

3. The method of claim 1, wherein said curve shaped area consists of 4 sections: the top curve section, the bottom curve section, the left tilted line, and the right titled line.

4. The method of claim 3, wherein said top and bottom curves can be either convex or concave.

5. The method of claim 3, wherein said top and bottom curves have same curvature.

6. The method of claim 3, where said left tilted line and said right titled line are symmetrical along the vertical central line of the display area.

7. The method of claim 1, wherein a plurality of said items are displayed vertically and each said item contains text(s) and/or image(s).

8. The method of claim 7, wherein said text(s) and/or image(s) can be grouped in a few curve lines.

9. The method of claim 7, wherein said text(s) and/or image(s) can be rendered independently in terms of text color and alignment, font characteristics, background color, image drawing effect, and so on.

10. The method of claim 1, where said image buttons are used to interact with said curve items list and other software, firmware, or combinations thereof.

11. An electronic device comprising:
a touch screen configured to display a plurality of items; and
a curve items list controller configured to execute specific computer executable instructions to perform the method of the claim 1.

12. The method of claim 11, wherein said touch screen can be operated in either portrait or landscape mode.

13. The method of claim 11, wherein said specific computer executable instructions can be stored in memory, USB, hard drive, and so on.

14. The method of claim 11, wherein said curve items list controller can detect vertical scrolling triggered by one finger, and thus some items are moved out of the curve shaped area and some items are moved into the curve shaped area. Furthermore, two scrollbars are displayed and faded out to indicate the motion direction and which part of the items list is visible.

15. The method of claim 11, wherein said curve items list controller can detect that one specific item is swiped rightward by one finger. Furthermore, if the rotation angle is equal to or greater than a predetermined value, an event can be generated and sent to a software program, a firmware module, or a combination thereof that performs associated functions.

16. The method of claim 11, wherein said curve items list controller can detect that one specific item is swiped leftward by one finger. Furthermore, if the rotation angle is equal to or greater than a predetermined value, an event can be generated and sent to a software program, a firmware module, or a combination thereof that performs associated functions.

17. The method of claim 11, wherein said curve items list controller can detect that two different items are touched and squeezed by two fingers. Furthermore, if the squeezing movement is equal to or greater than a predetermine value, an event can be generated and sent to a software program, a firmware module, or a combination thereof that performs associated functions.

18. The method of claim 11, wherein said curve items list controller can detect that one specific item is tapped by one finger, and thus an event can be generated and sent to a software program, a firmware module, or a combination thereof that performs associated functions.

19. The method of claim 11, wherein said electronic device may contain keyboard and/or mouse, and thus users may use keyboard and/or mouse instead of finger to vertically scroll through a curve items list and select a specific item.
